(19) United States
(12) Patent Application Publication
(10) Pub. No.: US 2011/0285648 A1
(43) Pub. Date: Nov. 24, 2011

(54) USE OF FINGERPRINT SCANNING SENSOR DATA TO DETECT FINGER ROLL AND PITCH ANGLES

(75) Inventor: Steven H. Simon, Oakland, CA (US)

(73) Assignee: Lester LUDWIG, Belmont, CA (US)

(21) Appl. No.: 13/009,845

(22) Filed: Jan. 19, 2011

Related U.S. Application Data
(60) Provisional application No. 61/297,631, filed on Jan. 22, 2010.

(51) Int. Cl. G06F 3/041

(52) U.S. Cl. 345/173; 178/18.03

(57) ABSTRACT

A method for detecting roll angles of a finger in contact with a fingerprint scanning sensor is described. The method includes obtaining spatial measurement data of a measurable contact area from a touch surface of a fingerprint scanning sensor, using an algorithm to create at least two statistical quantities from this spatial measurement data, using the statistical quantities to generate at least one measurement of a finger roll angle with respect to a reference position, and providing the roll angle measurement for external uses. This method can also be used to detect pitch angles of a finger contacting a fingerprint scanning sensor. The roll and pitch angles are calculated in real time and used for controlling applications on electronic devices such as computers and mobile phones.

### CROSS-REFERENCE TO RELATED APPLICATIONS

Pursuant to 35 U.S.C. §119(e), this application claims benefit of priority from provisional patent application Ser. No. 61/297,631, filed Jan. 22, 2010, the contents of which is incorporated by reference in its entirety.

### BACKGROUND OF THE INVENTION

This invention relates to the use of a High Dimensional Touchpad (HDTP) providing enhanced control capabilities to the control computer window systems, computer applications, web applications, and mobile devices, by using finger positions and motions comprising left-right, forward-backward, roll, pitch, yaw, and downward pressure of one or more fingers and/or other parts of a hand in contact with the HDTP touchpad surface.

The incorporation of the system and method of the invention allows for enhanced control of at least computer window systems, computer applications, web applications, and mobile devices. The inclusion of at least one of roll, pitch, yaw, and downward pressure of the finger in contact with the touchpad allows more than two interactive user interface parameters to be simultaneously adjusted in an interactive manner. Contact with more than one finger at a time, with other parts of the hand, and the use of gestures, grammar, and syntax further enhance these capabilities.

The invention employs an HDTP such as that taught in issued U.S. Pat. No. 6,570,078, and U.S. patent application Ser. Nos. 11/761,978 and 12/418,605 to provide easier control of application and window system parameters. An HDTP allows for smoother continuous and simultaneous control of many more interactive when compared to a mouse scroll wheel mouse. Tilting, rolling, or rotating a finger is easier than repeatedly clicking a mouse button through layers of menus and dialog boxes or dragging and clicking a button or a key on the keyboard. Natural metaphors simplify controls that had required a complicated sequence of actions.

### SUMMARY OF THE INVENTION

In one embodiment, the inventive method for detects finger roll angles from fingerprint scanning sensor data produced by a finger position in contact with the fingerprint scanning sensor. The roll angle with respect to a reference position is defined by a finger in contact with the fingerprint sensor.

Spatial data from a touch surface of a fingerprint scanning sensor is responsive to a finger contacting the touch surface that forms a measurable contact area. At least two statistical quantities is derived from the spatial measurement data as the data is processed with an algorithm. At least one quantity is calculated that is responsive to the roll angle of the finger with respect to a reference position of the finger. One or more outputs are provided that are responsive to the calculated quantities and to the finger roll angles.

In another embodiment, the inventive method detects finger pitch angle from fingerprint scanning sensor data produced by a finger position in contact with the fingerprint scanning sensor. The pitch angle with respect to a reference position is defined by a finger in contact with the fingerprint sensor.

In yet another embodiment, the roll and pitch angles are calculated in real time.

In yet another embodiment, a statistical average and a statistical moment of the fingerprint scanning sensor spatial data responsive to the measurable contact area are used to calculate the roll and pitch angles of the finger position.

### BRIEF DESCRIPTION OF THE DRAWINGS

The above and other aspects, features, and advantages of the present invention will become more apparent upon consideration of the following description of preferred embodiments, taken in conjunction with the accompanying drawing figures.

In the following detailed description, reference is made to the accompanying drawing figures which form a part hereof, and which show by way of illustration specific embodiments of the invention. It is to be understood by those of ordinary skill in this technological field that other embodiments can be utilized, and structural, electrical, as well as procedural changes can be made without departing from the scope of the present invention.

FIG. 1 depicts a user's finger on the HDTP and indicating the six degrees of freedom.

FIG. 2 shows high-level architecture of the HDTP.

FIGS. 3a and 3b depict, respectively, 2D and 3D representations of data measurement outputs from a tactile array sensor.

FIG. 4 shows an example of a user interface to view image representations of data measurements of a finger contacting a tactile sensor.

FIGS. 5a and 5b show variation of the shape and size of a contact region of a finger on a tactile sensor when the finger is pitched or rolled.

FIG. 6 shows the results of an algorithm used to evaluate repeated finger yaw movements.

FIG. 7 shows an exemplary hardware arrangement for an embodiment of the system.

FIG. 8 shows an exemplary software architecture structure for a demonstration system to view images of a finger generated by a tactile sensor.

FIG. 9 shows an exemplary software architecture structure for a production system to view images of a finger generated by a tactile sensor.

FIG. 10 shows an exemplary architecture for the analyzer module for meeting the independence and covariation conditions.

FIGS. 11a-11d depict exemplary user lever operations of one application, Map, for implementation on a smartphone.

FIG. 12 shows exemplary correlation between each of the six degrees of freedom and the functions performed by the application module.

FIGS. 13a and 13b show that the number of unique parameter values decreases as spatial dimensions are decreased.

FIGS. 14a and 14b show exemplary relationships between the spatial dimensions of the active area of the sensor and the effect on the performance of all measured parameters except heave.

FIGS. 15a-15d show examples of how accurately users can control the position of a cursor on a computer screen using each of the six basic one-finger movements in a 1D cursor control test

FIG. 15e shows an exemplary image presented to a user for controlling a cursor in a 2D cursor movement test.

### DETAILED DESCRIPTION OF THE PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments can be utilized, and structural, electrical, as well as procedural changes can be made without departing from the scope of the present invention. Wherever possible, the same reference numbers will be used throughout the drawings to refer to the same or similar parts.

The innovation of the high-dimensional touchpad (HDTP) include utilizing a matrix sensor with real-time image analysis hardware, firmware or software, to create a pointing and user input device with a number of desirable features including: (a) a large number of continuous, as well as discrete, degrees of freedom (DOFs); (b) natural, intuitive and efficient operation; (c) several DOFs that are available in an area about the size of a fingerprint; (d) gesture recognition and multitouch capabilities; (e) recognition of a variety of different forms of hand contact; (f) recognition of patterned sequences of contact; and (g) flexibility in the manner in which it is operated. The high-dimensional touchpad (HDTP) is described, for example, in U.S. Pat. No. 6,570,078 and pending U.S. patent application Ser. Nos. 12/418,605 and 11/761,978. A number of applications are described therein, as well as in pending U.S. patent application Ser. Nos. 12/511,930 and 12/541,948.

The HDTP augments widely familiar multitouch and categorical gestural capabilities with a capability to detect angles and very fine movements, allowing more information to be conveyed in a smaller area. As a result, the HDTP can be used to perform operations with a few small movements where the other interfaces require a greater number of physically larger movements. For these reasons, the HDTP represents a significant advance over other touch and pointing interfaces.

There are many possible ways in which the HDTP can be operated, but the following example illustrates one particularly noteworthy way, in which the user operates the touchpad with a single finger. As shown in FIG. 1, the finger has six DOFs relative to the surface of the HDTP, three translations and three rotations:
(1) side-to-side translations or sway;
(2) forward-back translations or surge;
(3) increased/decreased downward pressure or heave;
(4) side-to-side tilt or roll;
(5) forward-back tilt or pitch; and
(6) side-to-side swivel or yaw.

Movements in all six DOFs can be made using a surface with a very small area, about the size of a fingerprint. Each DOF can be assigned to a different action performed on an external system, allowing the user to carry out six independent actions with a single finger. And, because figure positions and movements—hereafter collectively referred to as “displacements—can all be made in a small area, the HDTP is well-suited for use in handheld devices.

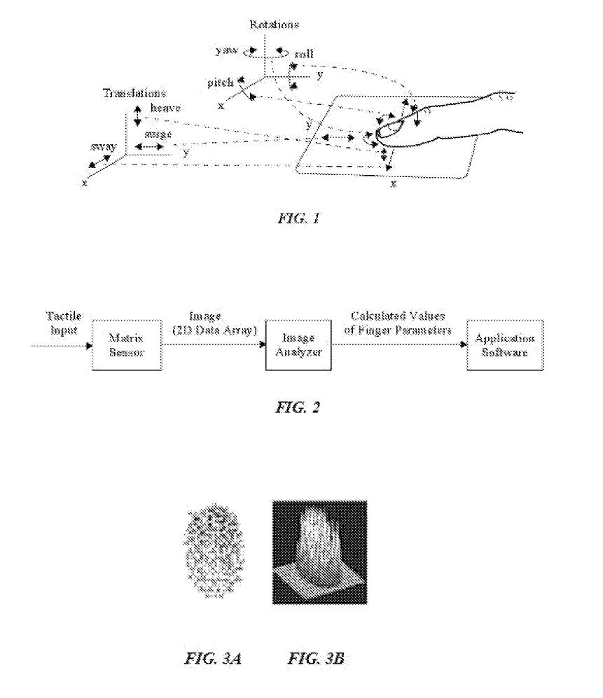

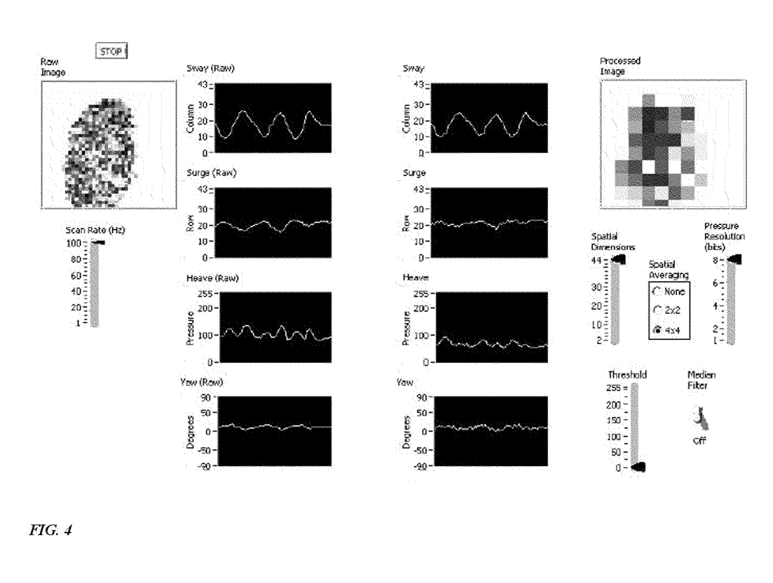

An exemplary high-level architecture of the HDTP is shown in FIG. 2. In an embodiment, the matrix sensor comprises a grid of independent sensing elements and provides a high-resolution image of the finger on the sensor surface. For example, one can use a tactile array sensor or tactile sensor, which measures the pressure applied to each element of the grid; sample output from the sensor is shown in the 2D and 3D graphs of FIG. 3a and FIG. 3b. However, other kinds of high-resolution sensors, such as fingerprint scanners, can be used. Some kinds of matrix sensors can be best suited for use in specific commercial products.

Images of measure data created by contact of a finger with the sensor creates are transmitted to an image analyzer module, which calculates the values of various parameters. In exemplary one-finger interactions, the parameters are the extents of the displacements of the finger in each of the six DOFs. Information the sensor provides about full aspects of finger displacements is incomplete, so it is difficult to calculate the parameters with great accuracy. However, only reasonably close approximations to the intended values of the parameters are needed for the operation of the HDTP. Calculated values can be transmitted to application software that performs different actions depending on the received values. For instance, the heave value can set the zoom level of a document, and the yaw value can rotate it.

The HDTP has unique capabilities that distinguish it from all other commercial and experimental touch interfaces. With the commercial introduction and acceptance of the iPhone®, touch interfaces have become a subject of keen commercial interest. The HDTP has a large number of possible applications, and is well suited for use in smartphones, laptops and other mobile computers. The HDTP also has considerable potential as an assistive device for the disabled, thus promoting the goal of universal access.

The HDTP can be implemented in a variety of different shapes and sizes, and can enhance the capabilities and improve the operation of a wide variety of different systems, among them:
(a) windowing systems and applications found on personal computers;
(b) smartphones and other handheld devices;
(c) CAD/CAM systems;
(d) machine control, telerobotics and other industrial systems;
(e) drawing and painting software applications;
(f) electronic musical instruments; and
(g) assistive technology for the disabled, where the HDTP's sensitivity to fine movement and flexibility in its manner of operation can be particularly valuable.

The afore described six DOF one-finger interaction techniques the HDTP makes possible can be augmented with other interaction techniques, including multitouch, gesture and shape recognition, and contextual interpretation of contact events or regions. As illustrative examples:
Each additional finger or thumb contact can add a presence event and three continuous parameters.
Contact with other parts of the hand can provide up to four additional presence events and two additional continuous parameters.
Combinations of these events and parameters can be used to add even more parameters. The presence events can be interpreted context free or in contexts determined by user applications or internal states.
Geometric shape, relative position, and other information can be used to recognize specific fingers and other parts of the hand, as well as particular postures, providing additional parameters.

As mentioned, the core idea of the HDTP is to utilize a high-resolution, matrix sensor to capture nuances of finger and hand movements that alternative touch interfaces cannot discern. High resolution tactile sensors appear suitable for meeting the technical requirements of the HDTP, but these can be expensive and the contact surface can need to be replaced periodically. A group of alternative types of sensors is summarized below:
(a) Resistive pressure sensor arrays employ a rectangular array of electrically-resistive pressure-sensing elements. They can offer higher spatial resolution but are subject to degradation over time. Resistive tactile array sensors are manufactured by Tekscan (Boston, Mass.), Sensor Products (Madison, N.J.), and XSENSOR (Calgary, Alberta, Canada). The use of pressure sensor arrays in general as a sensor in the HDTP is considered in U.S. Pat. No. 6,570,078 and pending U.S. patent application Ser. Nos. 12/418,605 and 11/761,978. The use of resistive pressure sensor arrays is further considered in pending U.S. patent application Ser. No. 12/418,605.
(b) Capacitive pressure sensor arrays employ a rectangular array of electrically-capacitive pressure-sensing elements. They offer lower spatial resolution and can be far less subject to degradation over time. Capacitive pressure sensor arrays are manufactured by Pressure Profile Systems Los Angeles, Calif.) and Synaptics (Santa Clara, Calif.). Note that a capacitive pressure sensor array is not the same as a capacitive matrix sensor (described immediately below). The use of pressure sensor arrays in general as a sensor in the HDTP is considered in U.S. Pat. No. 6,570,078 and pending U.S. patent application Ser. Nos. 12/418,605 and 11/761,978. The use of capacitive pressure sensor arrays is further considered in pending U.S. patent application Ser. No. 12/418,605.
(c) Capacitive matrix sensors often have a lower maximum spatial resolution than resistive ones, but are less expensive, more durable, and can be implemented in the form of transparent capacitive matrix touchscreen overlay elements, for example as used in the iPhone®. Information regarding the capacitive touchscreen sensor used in the iPhone is limited; suggestions of the specifications can be found in pre-grant patent application publication US 2007/0229464 that appears to be related to the iPhone. The use of sensor arrays in general as a sensor in the HDTP is considered in U.S. Pat. No. 6,570,078 and pending U.S. patent application Ser. Nos. 12/418,605 and 11/761,978. The use of capacitive matrix sensors as a sensor in the HDTP is considered in pending U.S. patent application Ser. No. 12/418,605.
(d) Fingerprint scanners have a significantly higher resolution than resistive tactile sensors, and the technology is mature, robust and inexpensive. The main drawback is their size, since the active area is only about the size of a fingerprint. These sensors do not measure pressure, but their high resolution provides other possible ways to calculate the finger parameters and to identify types of movements. For instance, as the pressure applied to the surface of a fingerprint scanner increases, the ridges of the fingerprint grow closer together. This pattern, and others like it, can be used to calculate surge, sway, heave and yaw. Preliminary work of this type can be found in U.S. patent application Ser. Nos. 11/017/115; 10/873,393; 11/102,227; 10/912,655; and 11/056,820. Manufacturers of fingerprint scanners include Authentec (Melbourne, Fla.), Microsoft (Redmond, Wash.), HP (Palo Alto, Calif.), APC/Scheider Electric (Kingston, R.I.), and Eikon (Brooklyn, N.Y.). Further, it is noted that Synaptics (Santa Clara, Calif.) and Authentec have collaborated to develop a touchpad that incorporates a fingerprint scanner for authentication.
(e) Palm scanners sensors do not measure pressure, but their high resolution provides other possible ways to calculate the finger parameters and to identify types of movements. Many palm scanners work by recognizing patterns of veins and wrinkles in the palm, and have a bigger active area and a lower resolution than fingerprint scanners. Palm scanner technology is less mature than fingerprint scanner technology, and palm scanners are more expensive, can have a very slow image frame rate, and often comprise significant data processing requirements. Palm scanners are manufactured by Crossmatch Technologies (Palm Beach Gardens, Fla.) and Fujitsu (North American Headquarters Sunnyvale, Calif.).
(f) Video cameras are mature, robust and inexpensive, and can be suitable for the HDTP. The use of video cameras, video images, and other types of optical imaging sensors as a sensor in the HDTP is taught in U.S. Pat. No. 6,570,078 and pending U.S. patent application Ser. Nos. 12/418,605 and 11/761,978.

A high-resolution, matrix sensor can generate data which, when rendered as images, provide sufficient visible information to distinguish displacements of a finger in all six possible DOFs. From such a matrix sensor it is possible to calculate values for the displacements so that a user can generate measured real-time variations in these values by moving a contacting finger; and to determine that suitable images can be generated with types of sensors appropriate for a production version of the HDTP.

Sensor output measurement data from such a sensor can be rendered as visual images that can be used to view images of the contact of a finger generated in real time by the sensor. Such real-time images can be provided together with real-time plots of parameter values calculated from the data represented by the visual images. These can be combined in a system that further allows observation of the effects on these images and plots of applying various image and data processing operations to the sensor output measurement data. An exemplary user interface for an exemplary such system is shown in FIG. 4. In this embodiment the images and plots generated by calculating values from the raw output measurement data appear on the left, and the images and the corresponding plots generated by calculating values from processed output measurement data appear on the right. Controls for the image processing operations that can be applied to the images can be included, such as those that appear on the right under the finger image.

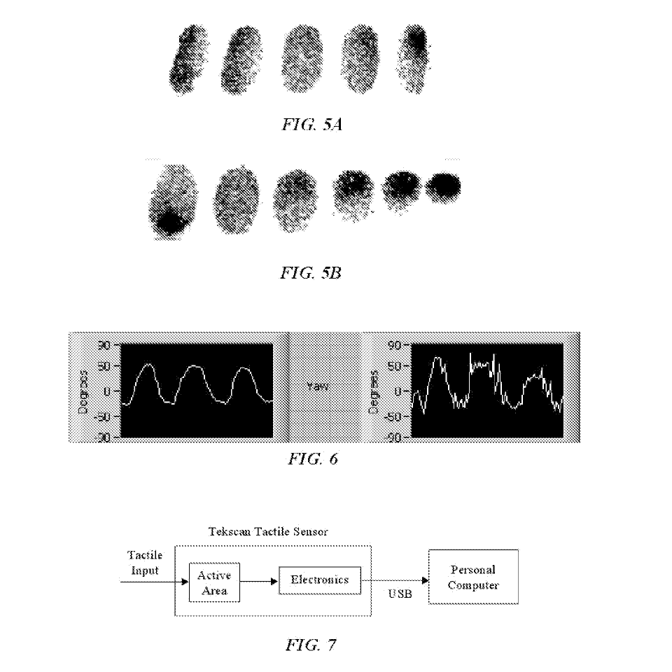

The rendered images provide enough visible spatial and pressure information to recognize and follow movements of a finger in all six DOFs. When the finger is neither pitched nor rolled, the images of finger contact with the sensor are usually elliptical comprising a region of relatively uniform distribution of pressure across them. There are clear, consistent variations in the shape and size of the contact region and the pressure distribution across it when the finger is pitched or rolled. The variations in the shape and size of the contact region and in the pressure distribution across it that result from making pitch and roll movements are visible in the exemplary sequences of images shown in FIG. 5a and FIG. 5b. There are clear, consistent variations in the orientation of the ellipse when the finger is rotated through a yaw angle. There are clear, consistent variations in the average pressure and size of the contact region when the finger is heaved. The data measurements generated by the sensor contain enough information for calculating measured finger displacement parameters and to measure the extents of the six displacements of a finger relative to the surface of a sensor with sufficient accuracy to track changes in them as they are made.

An important factor bearing on the commercial feasibility of the HDTP is the sensor characteristics required for adequate performance. The cost of the HDTP can depend significantly on what kind of sensor is used, and what kind of sensor can be used can depend significantly on what spatial dimensions, spatial resolution and pressure resolution are required.

A process for evaluating hardware requirements of the HDTP was to use a test program to view raw and processed images, and plots of parameter values calculated from the images, side-by-side. By observing the effect that a given operation had on the plot of a calculated parameter, it is possible to determine whether the effect was significant. This is illustrated in FIG. 6 for a case where two different thresholds were applied to the same images. In an exemplary embodiment, one can implement three image processing operations to modify the output from the sensor to simulate the use of sensors with other characteristics. A block averaging operation simulates a sensor with a lower spatial resolution, and an image cropping function simulates a sensor with a smaller active area. A function that masks the low order bits of the pixels in the images simulates a sensor with a lower pressure resolution. User controls can be provided for each operation. Exploration of relaxed sensor requirements can be useful because if sensors with less expensive characteristics can be used for the HDTP, a number of alternative tactile sensors can be well-suited for use in a commercial product.

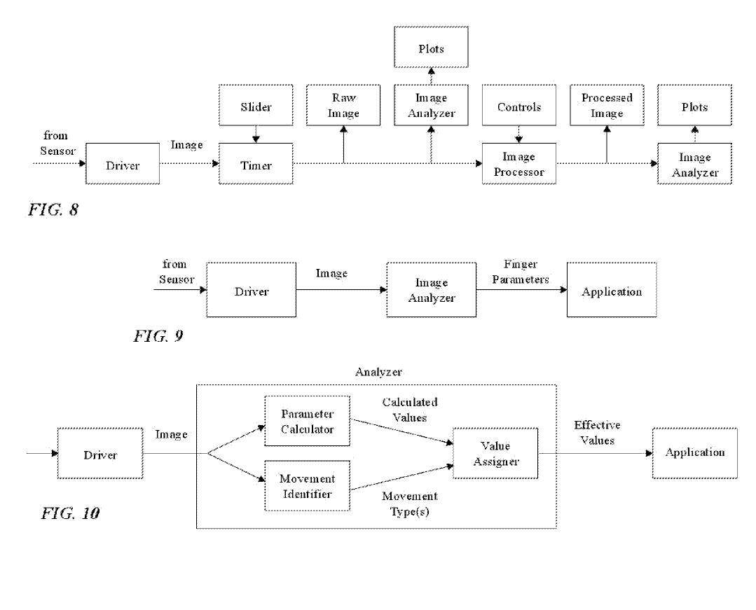

In an exemplary embodiment, the hardware components of the system are a matrix sensor and a personal computer linked by a USB cable, as shown in FIG. 7. Software architectures of an exemplary demonstration system and of an exemplary production system are shown, respectively, in FIGS. 8 and 9.

In an exemplary embodiment, an I-Scan 5027 resistive tactile sensor from Tekscan (Boston, Mass.), with a spatial resolution of 0.63 mm, spatial dimensions of 2.8×2.8 cm², a pressure resolution of 8 bits per pixel (bpp), a pressure range of 0-2586 torr (mmHg), i.e., ˜50 lbs. per square inch or ˜3.5 kg/cm², and a scan rate of 30-100 frames per second can be used as a matrix sensor. Although the spatial dimensions of the active area of this sensor are somewhat small, it has the highest spatial resolution of any commercial tactile sensor found. For that reason, it provides means for assessing technical aspects of the HDTP.

In an exemplary embodiment, the inventive system comprises three main software components: a driver module that provides a software and data interface to the hardware sensor; an analyzer module that processes images received from the driver to calculate parameter values; and one or more application module(s) that carry out actions at the user level based on the input it receives from the analyzer module.

The driver module can be implemented in various ways and in some situations may be provided by the sensor manufacture. In other situations a custom driver can be created.

The analyzer module implements the algorithms for recovering the displacements of a finger in the six possible DOFs and for calculating additional parameters as additional interaction techniques are developed. This section will focus on the finger parameters.

The problem of finding algorithms to calculate the displacements can be divided into three smaller problems:
(a) tracking changes in the displacements as they are made,
(b) distinguishing each displacement from the others, and
(c) identifying displacements in more than one DOF at a time.

Addressing the first problem will enable users to act on a target system by moving their fingers in any of the six DOFs. Addressing the first two problems will enable users to act on the system in six independent ways. And addressing all three problems will enable users to act on the system in more than one way at a time, as well as independently. Algorithms that solve the first problem address a measurement condition, ones that solve the first two problems also address an independence condition, and ones that solve all three problems also address a covariation condition. The algorithms at least meet the measurement condition.

For sway, calculating the mean of the x-coordinates of the pixels in a data image {p_{xy}} whose measured values exceeds a threshold value Threshold results in responsive measurements. Similarly for surge, calculating the mean of the y-coordinates of the non-zero pixels in each data image {p_{xy}} whose measured values exceeds a threshold value Threshold results in responsive measurements. For heave, calculating the mean of the measured values that exceed a threshold value Threshold in the data image produces responsive measurements. As an example, the algorithms can implement the following calculations

$$Sway = \frac{{\sum }_{u = 0}^{M - 1} {\sum }_{v = 0}^{N - 1} v}{L} \qquad EQ . 1$$

for values of ν such that p_{μν}>Threshold

$$Surge = \frac{{\sum }_{u = 0}^{M - 1} {\sum }_{v = 0}^{N - 1} u}{L} \qquad EQ . 2$$

for values of ν such that p_{μν}>Threshold

$$Heave = \frac{{\sum }_{u = 0}^{M - 1} {\sum }_{v = 0}^{N - 1} {p}_{uv}}{L} \qquad EQ . 3$$

for values of μ and ν such that p_{μν}>Threshold

where M is the number of rows of the data image, N is the number of columns of the data image, p_{uν} is the pressure at row u and column ν, and L is the number of “loaded” (i.e., such that p_{uν}>Threshold) pixels in the image.

For yaw, an algorithm, based on a known technique for determining the rotation angle of an object in an image can be used. The algorithm has two main steps, calculating the second moment of inertia (MOI) tensor for the non-zero pixels in the image, and then applying a singular value decomposition (SVD) to the resulting matrix. The algorithm for calculating the MOI can be expressed as

$$M O I = [ \begin{matrix}\frac{{\sum }_{u = 0}^{M - 1} {\sum }_{v = 0}^{N - 1} {v}^{2}}{L} - {X}^{2} & \frac{{\sum }_{u = 0}^{M - 1} {\sum }_{v = 0}^{N - 1} uv}{L} - XY \\ \frac{{\sum }_{u = 0}^{M - 1} {\sum }_{v = 0}^{N - 1} uv}{L} - XY & \frac{{\sum }_{u = 0}^{M - 1} {\sum }_{v = 0}^{N - 1} {u}^{2}}{L} - {Y}^{2}\end{matrix} ] \qquad EQ . 4$$

for values of μ and ν such that p_{μν}>Threshold

where Y is the mean y-coordinate of the “above threshold” pixels (calculated above as Surge), and X is the mean x-coordinate of the “above threshold” pixels (calculated above as Sway). The meaning of the other variables is the same as in the equations above. Applying the SVD to MOI gives a product of three 2×2 matrices

SVD(MOI)=USV^{T} EQ. 5

Although the SVD operation handles more general cases, in the case of a 2×2 matrix it amounts to a canonical representation of the 2×2 matrix where the matrices U and V are unitary matrices and hence equivalent to a 2×2 rotation matrix. The rotation angle represented corresponds to the yaw angle, and as a rotation matrix has elements comprising sine and cosine of the rotation angle, the yaw angle can be then calculated, for example, from a column of the matrix U, as

$$Y A W = arctan ( \frac{U [ 1 , 1 ]}{U [ 0 , 1 ]} ) . \qquad EQ . 6$$

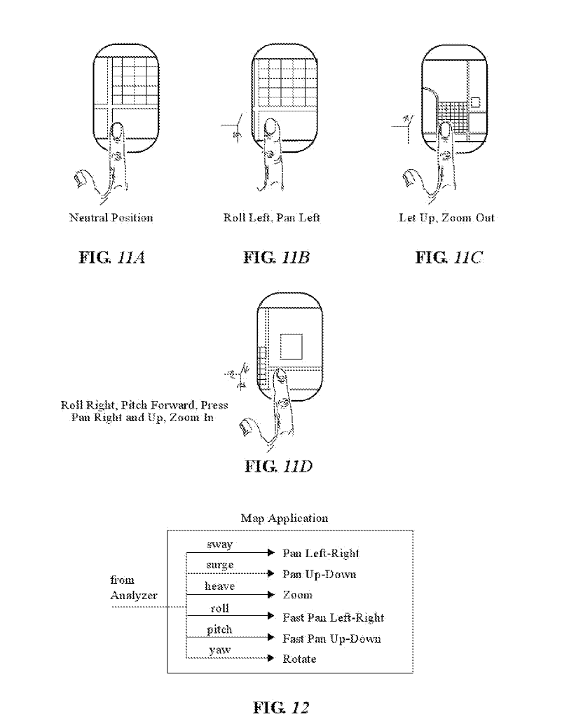

FIG. 10 shows an exemplary architecture for the analyzer module for meeting both independence and covariation conditions. The analyzer module described earlier contained a single component, which calculates values for each parameter and transmits them directly to the plotting functions. By contrast, in the exemplary analyzer module shown in FIG. 10, the calculation of the values occurs in a first sub-module, the Parameter Calculator, and the assignment of those values as the effective values of the parameters—that is, the values that are transmitted to the Application module—occurs in a separate sub-module, the Value Assigner. By isolating the assignment of values from their calculation, the Analyzer can filter spurious changes in parameter values, and transmit only the values that reflect the actual displacement of the finger.

The Assigner determines what kind of movement is being made, and so what parameters to update, based on the input it receives from a third component of the Analyzer, the Movement Identifier. As the name suggests, the Identifier determines what parameters should be updated by determining what kind of movement is being made. Inspection of finger images generated by the tactile sensor such as those shown in FIG. 5a and FIG. 5b, suggests there are a number of markers that could be used to distinguish different kinds of movements. For instance, when a finger pitches forward or back, there are discernible changes in the area of the contact region, in the vertical distance across it, in its shape, and in the pressure distribution across it. This collection of changes, or some subset, provides an example marker of a pitch movement.

The example system provides for one or more application module(s) that carry out actions at the user level based on the input it receives from the analyzer module. These can be used to test the image analysis algorithms and for use in human studies. Examples are considered in the next section.

It is important to include consideration of applications using and demonstrating the capabilities of the HDTP. Here, a detailed exemplary application is considered, and considerations are provided regarding additional exemplary applications.

As an example of such an application, which will be called Map, enables users to manipulate an image of a geographic map using one-finger interactions. Other applications can also be implemented that enable users to control with commands using a variety of touch interaction techniques.

In an exemplary implementation of Map, each type of one-finger displacement manipulates the displayed map image in a different way. The user interface is most effective if the displacement of the finger relates in a strong metaphor to the manipulation For example, roll pans the displayed map image horizontally, pitch pans the displayed map image vertically, yaw rotates the displayed map image around the center of the viewing area, and heave controls the zoom level. In an embodiment, sway pans the map horizontally (like roll), but by a different amount, so one of roll or sway can be used for gross adjustments and the other of roll and sway can be used for fine ones. Similarly, surge pans the displayed map image vertically by a different amount than pitch. In this way, the HDTP's capacity to distinguish roll from sway movements and pitch from surge movements can be comparatively demonstrated and utilized.

An example of user-level operation of Map is illustrated in FIG. 11a-FIG. 11d in an implementation for a smartphone. In FIG. 11a, the finger is in a neutral position, with no rotations. In FIG. 11b, the finger is rolled left, and the map pans left. In FIG. 11c, the pressure applied to the sensor is reduced and the map zooms out. In FIG. 11d, the user simultaneously rolls her finger right, pitches it forward and reduces the applied pressure, and the image pans right and up, and is zoomed in. (The type and direction of the movements made in each case are indicated in the figure with the axes and the arrows.)

Applications can be implemented by implementing the application module of the prototype. In Map, the application module scales the values of the finger parameters to ranges appropriate for manipulating the map image, and updates the image according to the types and extents of the movements made, as shown in FIG. 12. Other applications can be implemented in place of Map to respond to more kinds of movements.

Map requires functions to pan, zoom, rotate and display an image. A single function, taking a horizontal and a vertical distance as arguments, can be used for all four pan operations. Other exemplary functions can be used when other movements are made.

Map requires an Analyzer that meets the independence condition. Map can be used to test an Analyzer implementation to confirm it meets the covariation condition.

Other applications can use the expanded repertoire of touch interactions the HDTP makes possible, and how they can make operating a familiar existing application easier and more efficient. In the expanded repertoire, more types of one-finger interactions are provided, and they are augmented with interaction techniques such as multitouch, gestures and recognition of different parts of the finger or hand—for instance, a quick yaw rotation to the left, a quick yaw rotation to the right, a slow yaw rotation, a thumb tap and a yaw rotation using two fingers can be used.

Files of recorded sensor output can be created using software similar to the software described earlier. To make each sample, an experimenter can oscillate a finger in a single DOF while observing a real-time plot of the calculated displacement, with the aim of making the plot as sinusoidal as possible. To simulate sensors with smaller active areas than the high resolution sensor, outer rows and columns of the images were removed before the parameters were calculated, and the experimenter reduced the amount the finger moved in generating sinusoidal plots for the calculated values.

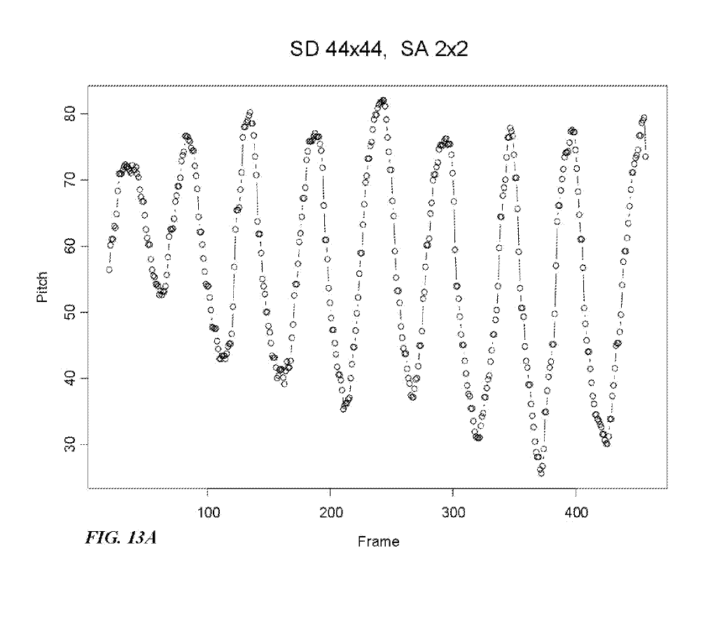

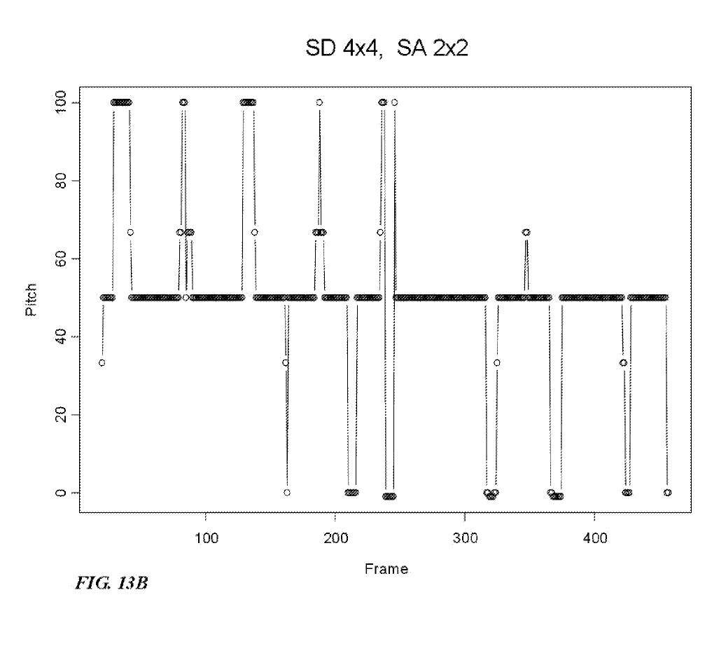

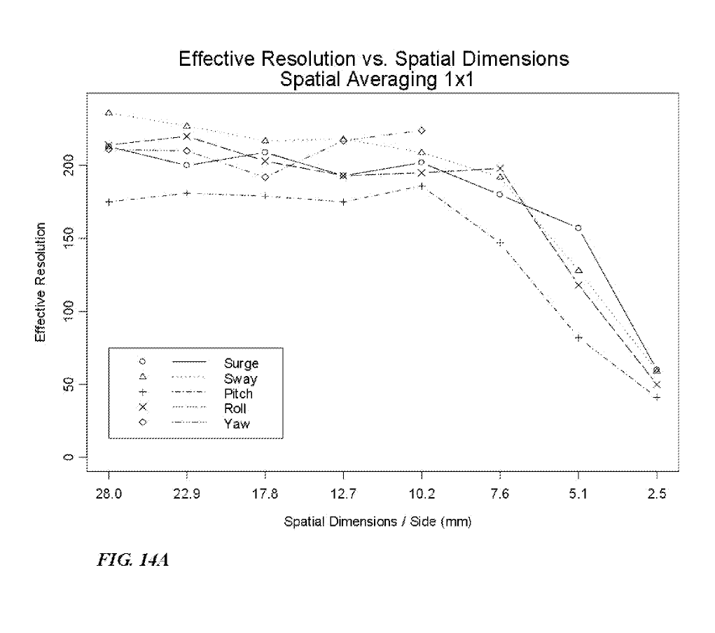

The aforementioned software can be written in a language such as Visual C++/CLI. The software can apply block averaging and bit reduction operations to the recorded output to simulate sensors with lower spatial and pressure resolutions. To analyze the data generated by the processing program, an effective resolution quantity can be defined as the number of unique parameter values that occur across the number of finger oscillations used to create each sample. FIG. 13a and FIG. 13b show how the number of unique parameter values decreases when the spatial dimensions are reduced. Note that effective resolution is not the same as spatial resolution, and can be much higher.

A procedure for evaluating candidate algorithms for calculating measured finger displacement parameters can be based on the observation that they must produce values that vary in a smooth, predictable way when users make smooth, regular movements. Otherwise, the algorithms would not be suitable for controlling a system. For example, one could observe whether the algorithms could generate sinusoidal real-time plots of the values calculated for a parameter by oscillating a finger in the corresponding DOF. An example of a plot generated for a repeated yaw movement is shown on the left side of FIG. 6.

In some applications some reductions in the spatial dimensions and spatial and pressure resolution can have only a limited impact on the performance of the HDTP. This can be significant since characteristics needed for adequate performance of the HDTP will determine what types of sensors it can use, and the type of sensor used in production can be a significant factor determining its cost.

To obtain systematic evaluation, a set of experiments can be performed to compare the performance of a high resolution sensor with that of sensors with different characteristics by processing the output of the high resolution sensor to simulate output from the other sensors. By using one sensor to simulate others, one can determine how sensors can be customized for use in the HDTP.

Using the systems and software such as described above, various results can be obtained and interpreted regarding aspects of a product HDTP system design or specification. Such results can also be used for other purposes, such as aspects of application design.

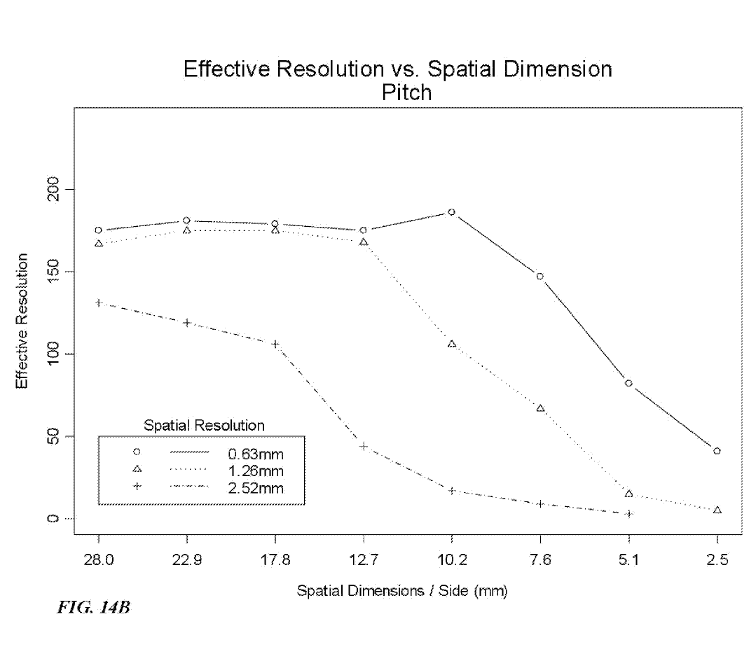

Results may include:
Reducing the spatial dimensions of the active area of the sensor by half can only have a marginal effect on performance of all parameters except heave for a spatial resolution of 0.63 mm, as shown in FIG. 14a.
System performance can be affected moderately by reducing the spatial resolution, but can still be adequate for many applications. FIG. 14b shows how the effective resolution for pitch varies as a function of spatial dimensions for three different spatial resolutions.
There was a moderate effect on system performance when the pressure resolution was reduced (recall that the calculations of the other parameters do not use pressure information.) However, the reduction in effective resolution for heave was small when the pressure resolution was reduced by a smaller amount.

These results can be taken to imply the following implications regarding what kinds of sensors can be used for the HDTP:
(a) Because system performance is largely unaffected by reducing the spatial dimensions of the sensor, a fingerprint scanner using similar image analysis algorithms should provide comparable performance for all parameters except heave; heave would require different algorithms since fingerprint scanners provide no direct pressure information.
(b) Because the effect on system performance for the parameters tested of reducing the spatial resolution moderate, a capacitive tactile sensor should be suitable for many applications.
(c) A sensor with even a modest pressure resolution can be used to calculate heave with enough precision to provide useful functionality.

The ultimate goal in developing the HDTP is to create a touch interface that is more usable than alternative touch interfaces and pointing devices—that is, an interface that is more intuitive, efficient and appealing than the alternatives. Therefore, human studies to evaluate the performance of the HDTP can be of importance.

As an example, a HDTP human study could comprise three kinds of tests:
(a) 1D cursor control using one parameter at a time,
(b) 2D cursor control using two parameters at a time, and
(c) functional tests in circumstances approximating those of actual use.

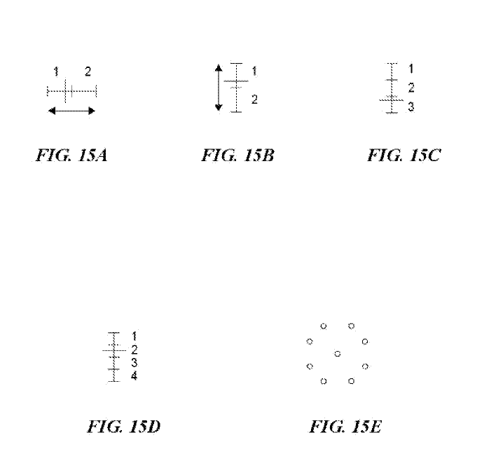

The 1D cursor control tests can evaluate how accurately users can control the position of a cursor on a computer screen using each of the six basic kinds of one-finger movements. Human subjects can be presented with a line segment oriented vertically or horizontally depending on the type of movement, and are able to adjust the position of a cursor fixed to move along the line by making the movement. The line can initially have a single graduation mark, as shown in FIG. 15a and FIG. 15b. As the test progresses, the number of graduations can be increased, as shown in FIG. 15b through FIG. 15d for the vertical line. In each case, the subject can be provided a set amount of time to move the cursor from one end of the line to a specified segment, and to maintain that position for a specified interval. By gradually increasing the number of graduations, the relative accuracy with which a subject can make each kind of movement can be determined, based on the error rate.

A 2D cursor control test can determine how efficiently a user can control a cursor moving in two dimensions with three different combinations of movements, surge and sway, pitch and roll, and heave and yaw. Human subjects can be presented with an image consisting of several small circles, one in the center and the rest at a fixed distance from the center and from each other, as shown in FIG. 15e. In this test, the initial position of the cursor can be at the circle in the center, with the goal of moving the cursor to a designated circle on the periphery. By timing how long it takes to do so, it is possible to determine how efficiently users can control a cursor by making each pair of movements.

Two functional tests can be used to compare the performance of the HDTP, a mouse, a conventional touchpad, and an advanced touchpad. Human subjects can use the Map application to navigate from one point on a map to another. In the other test, subjects can use other applications to carry out tasks such as navigating and editing. Timing how long it takes to complete the same task for each kind of interface provides a relative measure of efficiency. This approach is applicable to the conduct both small-scale and large-scale functional tests, and can use questionnaires in the large-scale tests to assess subjects' views of the relative merits of the different interfaces.

Analysis of the data produced by these tests can be used to establish various conclusions with associated degrees of statistical accuracy. Some example conclusions include:
(a) relative accuracy achieved for each basic kind of one-finger movement,
(b) relative efficiency of different pairs of one-finger movements,
(c) relative efficiency using different touch interfaces including the HDTP to carry out various tasks, and
(d) assessment of subjects' preferences regarding the different interfaces.

While the invention has been described in detail with reference to disclosed embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. Therefore, the invention properly is to be construed with reference to the claims.

I claim:

1. A method for detecting finger roll angle information from measurement data produced by a fingerprint scanning sensor, the roll angle defined with respect to a reference position of the finger in contact with the fingerprint sensor, the method comprising:
receiving measurement data from a fingerprint scanning sensor having a touch surface and creating spatial measurement data responsive to a finger contacting the touch surface with a measurable contact area;
processing the spatial measurement data with an algorithm producing at least two statistical quantities derived from the spatial measurement data;
performing calculations on the at least two statistical quantities to obtain at least one calculated quantity responsive to the roll angle of the finger with respect to a reference position of the finger; and
providing output information responsive to the at least one calculated quantity,
wherein the output information is responsive to the roll angle of the finger.

2. The method of claim 1, wherein the fingerprint scanning sensor provides updated measurement data in real-time as perceived by a user.

3. The method of claim 2, wherein the output information is updated in real-time as perceived by a user.

4. The method of claim 1, wherein at least one of the at least two statistical quantities is responsive to the measurable contact area.

5. The method of claim 1, wherein at least one of the at least two statistical quantities is responsive to a calculated statistical average of measurement data from a region of the measurable contact area.

6. The method of claim 1, wherein at least one of the at least two statistical quantities is responsive to a calculated statistical moment of measurement data from a region of the measurable contact area.

7. The method of claim 1, wherein the fingerprint scanning sensor is built into a computer.

8. The method of claim 1, wherein the fingerprint scanning sensor serves as a user interface touchpad.

9. The method of claim 1, wherein the output information is used to control an aspect of a software application running on a computer.

10. The method of claim 1, wherein the output information is used to control an aspect of a software application running on a handheld device.

11. A method for detecting finger pitch angle information from measurement data produced by a fingerprint scanning sensor, the pitch angle defined with respect to a reference position of the finger in contact with the fingerprint sensor, the method comprising:
receiving measurement data produced by a fingerprint scanning sensor having a touch surface and creating spatial measurement data responsive to a finger contacting the touch surface with a measurable contact area;
processing the spatial measurement data with an algorithm producing at least two statistical quantities derived from the spatial measurement data;
performing calculations on the at least two statistical quantities to obtain at least one calculated quantity responsive to the pitch angle of the finger with respect to a reference position of the finger; and
providing output information responsive to the at least one calculated quantity,
wherein the output information is responsive to the pitch angle of the finger.

12. The method of claim 11, wherein the fingerprint scanning sensor provides updated measurement data in real-time as perceived by a user.

13. The method of claim 12, wherein the output information is updated in real-time as perceived by a user.

14. The method of claim 11, wherein at least one of the at least two statistical quantities is responsive to the measurable contact area.

15. The method of claim 11, wherein at least one of the at least two statistical quantities is responsive to a calculated statistical average of measurement data from a region of the measurable contact area.

16. The method of claim 11, wherein at least one of the at least two statistical quantities is responsive to a calculated statistical moment of measurement data from a region of the measurable contact area.

17. The method of claim 11, wherein the fingerprint scanning sensor is built into a computer.

18. The method of claim 11, wherein the fingerprint scanning sensor serves as a user interface touchpad.

19. The method of claim 11, wherein the output information is used to control an aspect of a software application running on a computer.

20. The method of claim 11, wherein the output information is used to control an aspect of a software application running on a handheld device.
